(19) United States
(12) Patent Application Publication
(10) Pub. No.: US 2004/0101000 A1
(43) Pub. Date: May 27, 2004

(54) Laser system for dual wavelength and chip scale marker having the same

(75) Inventors: You Hie Han, Daejeon-city (KR); Chang Su Jun, Seoul (KR)

Correspondence Address: BURNS DOANE SWECKER & MATHIS L L P, POST OFFICE BOX 1404, ALEXANDRIA, VA, 22313-1404, US

(73) Assignee: EO Technics Co., Ltd., Kyungki-do (KR)

(21) Appl. No.: 10/611,951

(22) Filed: Jul. 3, 2003

(30) Foreign Application Priority Data
Nov. 27, 2002 (KR) 2002-74350

(51) Int. Cl. H01S 3/10

(52) U.S. Cl. 372/22

(57) ABSTRACT

A laser system for a dual wavelength of 1064/532 nm includes a laser oscillator oscillating a laser beam, a second harmonic generation module receiving the laser beam from the laser oscillator and generating a second harmonic wavelength, and a reflection mirror detachably arranged between the oscillator and the second harmonic generation module to reflect the laser beam oscillated by the laser oscillator in one direction when installed on a laser beam path. The laser system oscillates a laser beam having a 1064 nm wavelength when the reflection mirror is installed on the laser beam path and a laser beam having a 532 nm wavelength when the reflection mirror is detached from the laser beam path.

### BACKGROUND OF THE INVENTION

This application claims the priority of Korean Patent Application No. 2002-74350 filed Nov. 27, 2002 in the Korean Intellectual Property Office, the disclosure of which is incorporated herein in its entirety by reference.

1. Field of the Invention

The present invention relates to a laser system for a dual wavelength and a chip scale marker having the same, and more particularly, to a chip scale marker which performs marking by selecting a laser wavelength according to the presence of coating on a marking surface.

2. Description of the Related Art

Several thousands or tens of thousands of chips are formed on a wafer used in a semiconductor process. To classify the chips according to production lots, characters and/or numbers are marked on a surface of each chip. A chip scale marker using a laser beam is used as an equipment for marking. Previously, lot numbers are marked on small chips which are diced. As integrated circuits (ICs) become smaller and lighter due to the development of relevant technologies, to improve work efficiency and mass production, marking is first performed on each chip on the wafer and dicing is carried out. The wafer has a surface-mounted circuit on one side and lot number marking on the other side.

Recently, chips are deposited in multiple layers by making a thickness of a wafer thin and a marking surface is coated with epoxy molding compound (EMC) having a black color. In general, a silicon wafer surface is marked by using a Nd:YAG 532 nm laser wavelength having a high absorption rate and a high resolution with respect to a silicon wafer while the EMC coated surface is preferably marked by using a Nd:YAG 1064 nm laser wavelength.

FIG. 1 is a view illustrating a constitution of a general laser system including a wafer holder and a wafer. FIG. 2 is a plan view illustrating a constitution of a conventional chip scale marker adopting the laser system of FIG. 1.

Referring to FIG. 1, a laser system 10 includes a laser oscillator 11 providing a laser beam and a Galvano scanner 13 and an f-θ lens 15 sequentially disposed on a path of a laser beam emitted from the laser oscillator 11. The Galvano scanner 13 includes X and Y mirrors 13a and 13b and a motor (not shown) driving the X and Y mirrors 13a and 13b and scans the laser beam on a predetermined area in X-Y directions by adjusting the position of the mirrors 13a and 13b. The f-θ lens 15 makes the incident laser beam form the same focal length with respect to the entire marking area. The above laser system is disclosed in Japanese Patent Publication No. H9-248692. A wafer holder 20 is arranged above the laser system 10 and a wafer w is disposed on the wafer holder 20.

Referring to FIG. 2, the laser system 10 is arranged directly under the wafer holder 20 where the wafer w to be marked is placed (for the convenience, the laser system 10 is shown under the wafer holder 20). A robot arm 30 is arranged a predetermined distance from the wafer holder 20. Also, a wafer pre-aligner 40, a wafer cassette 51 containing wafers before marking, and a wafer cassette 52 containing wafers after marking are arranged in a range reachable by the robot arm 30.

In the operation of the chip scale marker having the above constitution, first, the robot arm 30 draws a wafer to be marked from the wafer cassette 51 and puts the wafer on the pre-aligner 40. Then, the pre-aligner 40 aligns the wafer with a reference of a notch N or a reference line R formed on the surface of the wafer as shown in FIG. 3.

Next, the preliminary aligned wafer is transferred to the wafer holder 20 by the robot arm 30 and the surface of the wafer is marked by the laser system 10. The marked wafer w is transferred to the wafer cassette 52 and contained therein.

However, the laser system 10 and the chip scale marker are manufactured to mark the wafer w by using a laser beam of one wavelength. When two types of wavelengths are needed, two different laser systems having different wavelengths must be installed, thus the installation cost of the laser system is increased.

### SUMMARY OF THE INVENTION

To solve the above and/or other problems, the present invention provides a laser system for a dual wavelength and a chip scale marker by which two types of wavelengths can be selectively used in a single laser system.

According to an aspect of the present invention, a laser system for a dual wavelength of 1064/532 nm, comprising a laser oscillator oscillating a laser beam;

a second harmonic generation module receiving the laser beam from the laser oscillator and generating a second harmonic wavelength; and a reflection mirror detachably arranged between the oscillator and the second harmonic generation module to reflect the laser beam oscillated by the laser oscillator in one direction when installed on a laser beam path, wherein the laser system oscillates a laser beam having a 1064 nm wavelength when the reflection mirror is installed on the laser beam path and a laser beam having a 532 nm wavelength when the reflection mirror is detached from the laser beam path.

The laser system further comprises a horizontal transfer unit or a rotation unit to detach or attach the reflection mirror from or on the laser beam path.

A chip scale marker for a dual wavelength of 1064/532 nm comprises a laser system including a laser oscillator oscillating a laser beam, a second harmonic generation module receiving the laser beam from the laser oscillator and generating a second harmonic wavelength, and a reflection mirror detachably arranged between the oscillator and the second harmonic generation module; a first Galvano scanner receiving a laser beam reflected by the reflection mirror and scanning the laser beam in X-Y directions; a first f-θ lens making the laser beam from the first Galvano scanner form the same focal length on an entire marking area; a first wafer holder supporting a wafer on which the laser beam passing through the first f-θ lens is irradiated; a second Galvano scanner receiving the laser beam passing through the second harmonic generation module from the laser oscillation and scanning the laser beam in the X-Y directions when the reflection mirror is detached from a laser beam path; a second f-θ lens making the laser beam from the second Galvano scanner form the same focal length on an entire marking area; and a second wafer holder supporting a wafer on which the laser beam passing through the second f-θ lens is irradiated.

The chip scale marker further comprises a horizontal transfer unit or a rotation unit to detach or attach the reflection mirror from or on the laser beam path.

According to another aspect of the present invention, the laser system and chip scale marker for a dual wavelength of 1064/355 nm wavelength includes a third harmonic generation module instead of the second harmonic generation module.

According to yet another aspect of the present invention, the laser system and chip scale marker for a dual wavelength of 1064/355 nm wavelength includes a fourth harmonic generation module instead of the second harmonic generation module.

### BRIEF DESCRIPTION OF THE DRAWINGS

The above and other features and advantages of the present invention will become more apparent by describing in detail preferred embodiments thereof with reference to the attached drawings in which:

FIG. 1 is a view illustrating a constitution of a general laser system including a wafer holder and a wafer;

FIG. 2 is a plan view illustrating a constitution of a conventional chip scale marker adopting the laser system of FIG. 1;

FIG. 3 is a view illustrating an example of a notch or a reference line formed in a wafer;

FIG. 4 is a view illustrating a constitution of a laser system for 1064/532 nm wavelengths according to a preferred embodiment of the present invention;

FIG. 5 is a plan view illustrating a constitution of a chip scale marker adopting the laser system of FIG. 4; and

FIG. 6 is a view illustrating a rotation unit of a first reflection mirror of FIG. 4.

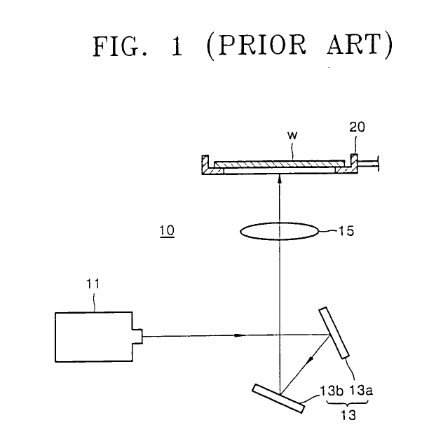

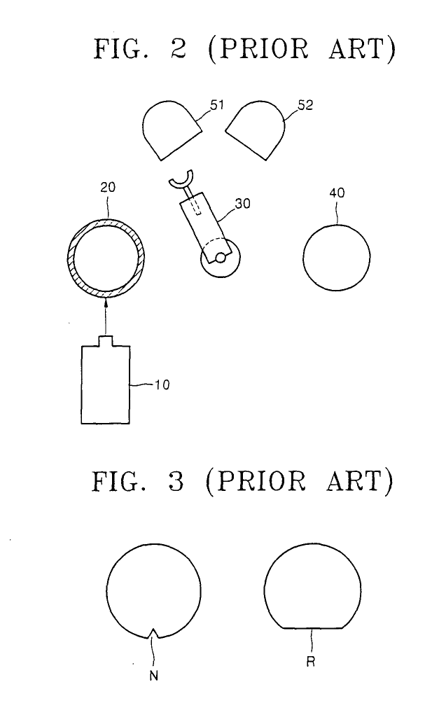

### DETAILED DESCRIPTION OF THE INVENTION

In the description below, a detailed description about the same constituent members as those described in the conventional technology will be omitted.

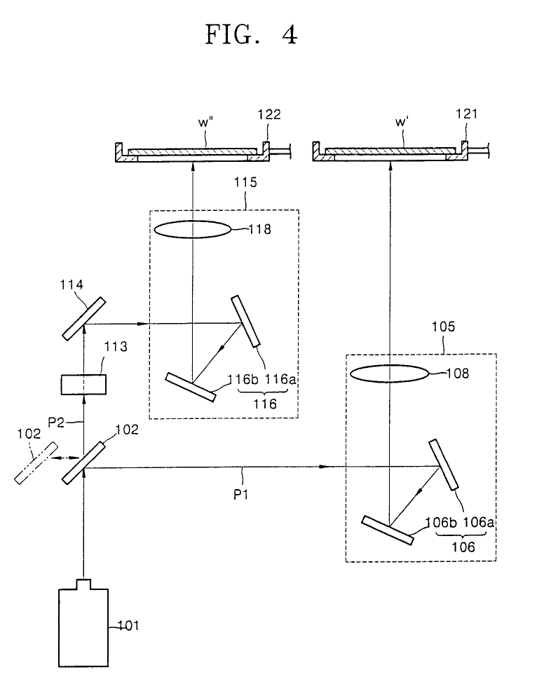

Referring to FIG. 4, a laser beam having a 1064 nm wavelength oscillated by a laser oscillator 101 is reflected by a first reflection mirror 102 to proceed along a first path P1. The laser beam reflected by the first reflection mirror 102 is irradiated on a wafer w through an optical unit 105 including a Galvano scanner 106 and an f-θ lens 108. The Galvano scanner 106 includes an X mirror 106a and a Y mirror 106b. A first wafer holder 121 and the wafer w′ are arranged directly above the optical unit 106 so that the laser beam oscillated by the laser oscillator 101 is irradiated on the wafer w′.

Meanwhile, when the first reflection mirror 102 is detached from a proceeding path of the laser beam, the laser beam proceeds along a second path P2. A second harmonic generation module 113 converting a base wavelength to a second harmonic wavelength, a second reflection mirror 114, a Galvano scanner 116 and an f-θ lens 118 which constitutes an optical unit 115, are sequentially arranged along the second path P2. Since the second wafer holder 122 and another wafer w″ are arranged directly above the optical unit 115, the laser beam oscillated by the laser oscillator 111 is irradiated on the wafer w″.

The basic wavelength or the second harmonic wavelength can be selectively used by detachably moving the first reflection mirror 102 with respect to the laser beam path. Thus, a desired harmonic wavelength can be conveniently selected according to the presence of coating on a marking surface of the wafer.

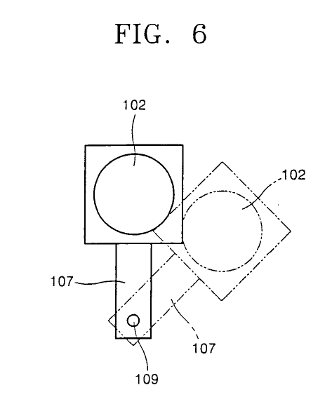

To detach the first reflection mirror 102 from the laser beam path, the first reflection mirror 102 can be moved to the left and right by using a horizontal transfer unit (not shown) as shown by an imagery line in FIG. 4. Alternatively, as shown in FIG. 6, a member 107 supporting the first reflection mirror 102 is rotated by a rotation unit (not shown) with respect to a support shaft 109 to detach the first reflection mirror 102 from the laser beam path.

In the operation of the laser system having the above constitution, first, when a laser beam having a basic wavelength is to be used, the first reflection mirror 102 is disposed on the laser beam path and a laser beam is oscillated by the laser oscillator 101. The oscillated laser beam is reflected by the first reflection mirror 102, proceeds along the first path P1, and irradiated on the wafer w′ after passing through the Galvano scanner 106 and the f-θ lens 108.

Next, when the second harmonic wavelength is to be used, first, the first reflection mirror 102 is detached from the laser beam path. That is, the first reflection mirror 102 is moved to the left as shown in FIG. 4 or rotated at a predetermined angle by the rotation unit around the support shaft 109 as shown in FIG. 6. Next, when a laser beam is oscillated by the laser oscillator 101, the laser beam having a basic wavelength passes through the second harmonic module 113 along the second path P2 and is converted to a second harmonic wavelength. Then, the proceeding direction of the second harmonic wavelength is changed by the second reflection mirror 114 so that the second harmonic wavelength is irradiated on the wafer w after passing through the Galvano scanner 116 and the f-θ lens 118.

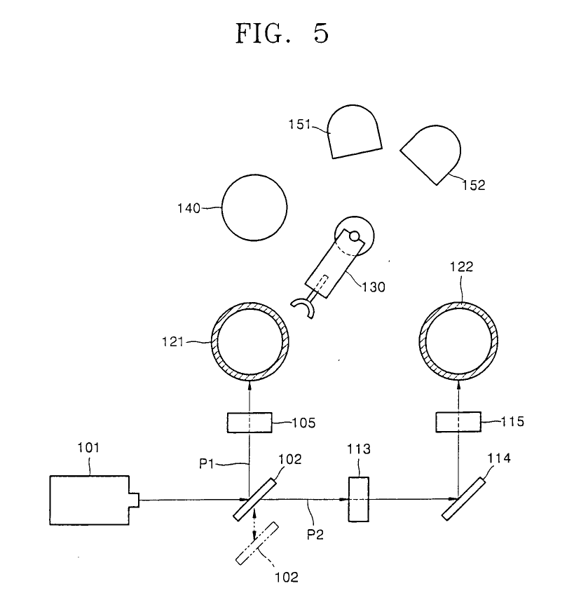

FIG. 5 is a plan view illustrating a constitution of a chip scale marker adopting the laser system of FIG. 4. Referring to FIG. 5, the first wafer holder 121 supporting a wafer to which a laser beam having a basic wavelength is irradiated and the second wafer holder 122 supporting a wafer to which a laser beam having a second harmonic wavelength is irradiated are arranged isolated from each other. The optical units 105 and 115 including the Galvano scanners 106 and 116 and the f-θ lenses 108 and 118 and the reflection mirrors 102 and 114 are arranged directly under the respective wafer holders 121 and 122 (for the convenience, they are shown under the wafer holders 121 and 122 in FIG. 5). The second harmonic generation module 113 is arranged between the first reflection mirror 102 and the second reflection mirror 114. Also, the robot arm 130 placing the wafer on and picking it out from the wafer holders 121 and 122, the two wafer cassettes 151 and 152 containing the wafers, and the pre-aligner 140 preliminarily aligning the wafer are arranged.

By detaching or attaching the first reflection mirror 102 from or on the laser beam path, the basic wavelength or the second harmonic wavelength can be selectively used so that a desired harmonic wavelength can be conveniently selected according to the presence of coating on a marking surface of the wafer.

To detach the first reflection mirror 102 from the laser beam path, the first reflection mirror 102 is moved up and down by using the horizontal transfer unit (not shown) as shown by an imaginary line of FIG. 5 or rotated with respect to the support shaft 109 by using the rotation unit as shown in FIG. 6.

The wafer holders 121 and 122, the pre-aligner 140, and the wafer cassettes 151 and 152 are arranged within a distance reachable by the robot arm 130. The first and second wafer cassettes 151 and 152 preferably contain the wafers using laser beams having different wavelengths for marking, respectively. When laser marking is performed by using only one wavelength, one of the wafer cassettes may contain wafers before marking and the other wafer cassette may contain wafers after marking.

The operation of the chip scale marker having the above constitution is described below with reference to the drawings.

First, a process of marking using a laser beam having a basic wavelength is described. The robot arm 130 picks a wafer to be marked from the first wafer cassette 151 containing wafers each having one surface which is EMC coated and puts the wafer on the pre-aligner 140. Then, the pre-aligner 140 performs pre-alignment using the notch N or reference line R formed in the wafer as reference.

Next, the robot arm 130 puts the pre-aligned wafer on the first wafer holder 121. When the first reflection mirror 102 is disposed on the laser beam path and then the laser oscillator 101 oscillates a laser beam, the laser beam is reflected by the first reflection mirror 102 to be irradiated on the wafer through the optical unit 105. The wafer which is marked is moved by the robot arm 130 from the first wafer holder 121 to the first wafer cassette 151 and stored in the first wafer cassette 151.

Next, the process of marking using a laser beam having a second harmonic wavelength is described. First, the first reflection mirror 102 is detached from the laser beam path. That is, the first reflection mirror 102 is detached from the laser beam path by using the horizontal transfer unit, as shown in FIG. 5, or by using the rotation unit as shown in FIG. 6. The robot arm 130 picks a wafer to be marked from the second wafer cassette 152 containing wafers having no EMC coated surface and puts the wafer on the pre-aligner 140. Then, the pre-aligner 140 performs pre-alignment using the notch N or reference line R formed in the wafer as reference.

Next, the robot arm 130 puts the pre-aligned wafer on the second wafer holder 122. When the laser oscillator 101 oscillates a laser beam, the laser beam passes through the second harmonic generation module 113 along the second path P2 and the wavelength of the laser beam is converted to a second harmonic wavelength. The laser beam having the second harmonic wavelength is reflected by the second reflection mirror 114 and passes through the optical unit 105 along the second path P2 so as to be irradiated to the wafer w. The wafer w which is marked is moved by the robot arm 130 from the second wafer holder 122 to the second wafer cassette 152 and stored in the second wafer cassette 152.

In the above preferred embodiment, the second harmonic generation module 113 which converts a laser beam having the basic wavelength oscillated by the laser oscillator 101 to a laser beam having the second harmonic wavelength is described. However, by using a third harmonic generation module or a fourth harmonic generation module instead of the second harmonic wavelength 113, the basic wavelength (1064 nm) can be converted to a third harmonic wavelength (355 nm) or a fourth harmonic wavelength (266 nm) with the same constitution as that described above. Since a constitution and operation of the laser system oscillating laser beams having two wavelengths are the same as those of the above-described preferred embodiment, a detailed description thereof will be omitted.

As described above, the laser system for a dual wavelength and a chip scale marker according to the present invention can conveniently select and use one of a laser beam having two wavelengths by using a single laser oscillator.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. A laser system for a dual wavelength of 1064/532 nm, comprising:
a laser oscillator oscillating a laser beam;
a second harmonic generation module receiving the laser beam from the laser oscillator and generating a second harmonic wavelength; and
a reflection mirror detachably arranged between the oscillator and the second harmonic generation module to reflect the laser beam oscillated by the laser oscillator in one direction when installed on a laser beam path,
wherein the laser system oscillates a laser beam having a 1064 nm wavelength when the reflection mirror is installed on the laser beam path and a laser beam having a 532 nm wavelength when the reflection mirror is detached from the laser beam path.

2. The laser system as claimed in claim 1, further comprising a horizontal transfer unit or a rotation unit to detach or attach the reflection mirror from or on the laser beam path.

3. A chip scale marker for a dual wavelength of 1064/532 nm, the chip scale marker comprising:
a laser system including a laser oscillator oscillating a laser beam, a second harmonic generation module receiving the laser beam from the laser oscillator and generating a second harmonic wavelength, and a reflection mirror detachably arranged between the oscillator and the second harmonic generation module;
a first Galvano scanner receiving a laser beam reflected by the reflection mirror and scanning the laser beam in X-Y directions;
a first f-θ lens making the laser beam from the first Galvano scanner form the same focal length on an entire marking area;
a first wafer holder supporting a wafer on which the laser beam passing through the first f-θ lens is irradiated;
a second Galvano scanner receiving the laser beam passing through the second harmonic generation module from the laser oscillation and scanning the laser beam in the X-Y directions when the reflection mirror is detached from a laser beam path;
a second f-θ lens making the laser beam from the second Galvano scanner form the same focal length on an entire marking area; and
a second wafer holder supporting a wafer on which the laser beam passing through the second f-θ lens is irradiated.

4. The chip scale marker as claimed in claim 3, further comprising a horizontal transfer unit or a rotation unit to detach or attach the reflection mirror from or on the laser beam path.

5. A laser system for a dual wavelength of 1064/355 nm, comprising:
a laser oscillator oscillating a laser beam;
a third harmonic generation module receiving the laser beam from the laser oscillator and generating a second harmonic wavelength; and
a reflection mirror detachably arranged between the oscillator and the third harmonic generation module to reflect the laser beam oscillated by the laser oscillator in one direction when installed on a laser beam path,
wherein the laser system oscillates a laser beam having a 1064 nm wavelength when the reflection mirror is installed on the laser beam path and a laser beam having a 355 nm wavelength when the reflection mirror is detached from the laser beam path.

6. The laser system as claimed in claim 5, further comprising a horizontal transfer unit or a rotation unit to detach or attach the reflection mirror from or on the laser beam path.

7. A chip scale marker for a dual wavelength of 1064/355 nm, the chip scale marker comprising:
a laser system including a laser oscillator oscillating a laser beam, a third harmonic generation module receiving the laser beam from the laser oscillator and generating a third harmonic wavelength, and a reflection mirror detachably arranged between the oscillator and the third harmonic generation module;
a first Galvano scanner receiving a laser beam reflected by the reflection mirror and scanning the laser beam in X-Y directions;
a first f-θ lens making the laser beam from the first Galvano scanner form the same focal length on an entire marking area;
a first wafer holder supporting a wafer on which the laser beam passing through the first f-θ lens is irradiated;
a second Galvano scanner receiving the laser beam passing through the third harmonic generation module from the laser oscillator and scanning the laser beam in the X-Y directions when the reflection mirror is detached from the laser beam path;
a second f-θ lens making the laser beam from the second Galvano scanner form the same focal length on an entire marking area; and
a second wafer holder supporting a wafer to which the laser beam passing through the second f-θ lens is irradiated.

8. The chap scale marker as claimed in claim 7, further comprising a horizontal transfer unit or a rotation unit to detach or attach the reflection mirror from or on the laser beam path.

9. A laser system for a dual wavelength of 1064/266 nm, comprising:
a laser oscillator oscillating a laser beam;
a fourth harmonic generation module receiving the laser beam from the laser oscillator and generating a fourth harmonic wavelength; and
a reflection mirror detachably arranged between the oscillator and the fourth harmonic generation module to reflect the laser beam oscillated by the laser oscillator in one direction when installed on a laser beam path, wherein the laser system oscillates a laser beam having a 1064 nm wavelength when the reflection mirror is installed on the laser beam path and a laser beam having a 266 nm wavelength when the reflection mirror is detached from the laser beam path.

10. The laser system as claimed in claim 9, further comprising a horizontal transfer unit or a rotation unit to detach or attach the reflection mirror from or on the laser beam path.

11. A chip scale marker for a dual wavelength of 1064/266 nm, the chip scale marker comprising:
a laser system including a laser oscillator oscillating a laser beam, a fourth harmonic generation module receiving the laser beam from the laser oscillator and generating a fourth harmonic wavelength, and a reflection mirror detachably arranged between the oscillator and the fourth harmonic generation module;
a first Galvano scanner receiving a laser beam reflected by the reflection mirror and scanning the laser beam in X-Y directions;
a first f-θ lens making the laser beam from the first Galvano scanner form the same focal length on an entire marking area;
a first wafer holder supporting a wafer to which the laser beam passing through the first f-θ lens is irradiated;
a second Galvano scanner receiving the laser beam passing through the fourth harmonic generation module for the laser oscillator and scanning the laser beam in the X-Y directions when the reflection mirror is detached from a laser beam path;
a second f-θ lens making the laser beam from the second Galvano scanner form the same focal length on an entire marking area; and
a second wafer holder supporting a wafer to which the laser beam passing through the second f-θ lens is irradiated.

12. The chap scale marker as claimed in claim 11, further comprising a horizontal transfer unit or a rotation unit to detach or attach the reflection mirror from or on the laser beam path.
